(19) United States
(12) Patent Application Publication
(10) Pub. No.: US 2014/0120888 A1
(43) Pub. Date: May 1, 2014

(54) Service which allows the subscribers to get to talk to all the parties in 1 single call as per the configured phones and have ability to record the conversation and add additional parties to the conversation by press of a button including emergency services.

(71) Applicant: Mahendra Bhegade, Fremont, CA (US)

(72) Inventor: Mahendra Bhegade, Fremont, CA (US)

(21) Appl. No.: 13/470,306

(22) Filed: Oct. 31, 2012

(51) Int. Cl. H04M 3/56

(52) U.S. Cl. CPC H04M 3/56
USPC 455/416; 379/205.01; 379/45

(57) ABSTRACT

There are many ways to communicate with multiple people at the same time, some of them are Conference Calls, Walkie Talkies, Facebook, Twitter and Text. Ability to communicate to multiple people can save time, money and sometime lives. Some of them means of communication (walkie talkie, push to talk) are comparatively expensive to setup. Adding additional participants to this setup takes time and resources. Some of them of not easily achievable and practical for a small set of people. Using the cateNet service you can setup this multi-party communication within few minutes, activate them at a touch of a button and still pay a little. The service is extensible and can eventual get together a very large set of people.

### BACKGROUND

How do people reach out to multiple people?

1. Conference Calls

2. Walkie Talkies

3. Facebook

4. Twitter

5. Text

6. Others

Have you ever thought of reaching out to multiple sets of people with a touch on a smart phone or by dialing a single number ?

Let's consider few real life examples and see where they can be beneficial.

Scenario 1. Critical customer service request.

A customer who can impact the operation stability of the corporation is having issues with a computer server which controls major operations of that company. Customer needs immediate resolution of the current issue.

If the person trying to resolve the customer's problem needs to talk to different individuals independently it will take longer, also he might need to consult individually with each one of them based on the responses. It would be more effective if he can reach the people involved and communicate at the same time.

Scenario 2. Family member requesting assistance.

Your teenager son just got a driver's license. Assuming that he gets into an accident and he unsure what to do. He will try to call his family members individually to determine the next steps. If he speaks to these family members individually they each might have a different way to address it. If he gets conflicting information from each one then he may be confused more and will not be able to make a good decision in time.

Scenario 3. Surgeon coordinating his team for an emergency.

A surgeon gets a call from hospital's emergency room requesting for his services. The surgeon needs to arrive at the hospital as soon as possible and needs to get surgical team (surgeon, anesthesiologist, lead nurse, assistant physician, etc.) on board, fill them in with the details of the case.

Only time available to do all this is while getting ready to arrive at the emergency room. The surgeon would call all his team members and instruct them individually. The same instructions will need to be repeated more than 2 times. A surgical team could have at least 6-7 folks working together on a given case.

Scenario 4. Senior family member requesting assistance.

It can become very challenging when the children are living in different states, and a senior family member needs assistance. If she needs some urgent help, she has to reach out to the children individually and explain them what she needs. It will be very annoying and ineffective if she has to talk to each one of them independently.

Scenario 5. Situation at a corporation.

Imagine a small company with a warehouse and a manufacturing plant. Assume a gas leak in the manufacturing plant, the first people to respond are the emergency response team to address emergency needs of the folks affected. Plant maintenance folks need to make sure that the gas leakage identified and shut off. Security personnel need to make sure people in the manufacturing plant are evacuated safely and nobody enters the plants. A coordinated effort is difficult if the individuals are on different groups on walkie talkies or push to talk phones, which is the typical case.

### BRIEF SUMMARY OF THE INVENTION

A service that allows you to communicate with multiple parties. Parties contacted are the ones that are setup. One can add additional participants as the communication progresses. You should be able to record conversation. You can activate additional communications from the existing communication. Multi-party communication can also be activated from a smart phone by just selecting the scenario to activate. If the participant misses the communication he can dial back and join the active communications.

### BRIEF DESCRIPTION OF THE DRAWINGS

FIG. 1. FIG. 1 illustrates how cateNet service will be used in a critical customer service request

FIG. 2. FIG. 2 illustrates how cateNet service in a critical customer service request contacts it participants

FIG. 3. FIG. 3 illustrates how cateNet service in a critical customer service, the participants participates and communicates with each other to resolve the situation.

FIG. 4. FIG. 4 illustrates how cateNet service in a critical customer service, the initiator identifies the next steps.

FIG. 5. FIG. 5 illustrates how cateNet service will be used in a family member requesting assistance

FIG. 6. FIG. 6 illustrates how cateNet service in a family member requesting assistance contacts it participants

FIG. 7. FIG. 7 illustrates how cateNet service in a family member requesting assistance the participants participates and communicates with each other to resolve the situation.

FIG. 8. FIG. 8 illustrates how cateNet service in a family member requesting assistance, the initiator acknowledges the help.

FIG. 9. FIG. 9 illustrates how cateNet service will be used in a situation where a surgeon is coordinating his team for an emergency

FIG. 10. FIG. 10 illustrates how cateNet service in a situation where a surgeon is coordinating his team for an emergency contacts it participants

FIG. 11. FIG. 11 illustrates how cateNet service in a situation where a surgeon is coordinating his team for an emergency, the participants participate and communicate with each other to resolve the situation.

FIG. 12. FIG. 12 illustrates how cateNet service in a situation where a surgeon is coordinating his team for an emergency, the initiator identifies the next steps.

FIG. 13. FIG. 13 illustrates how cateNet service will be used in a senior family member requesting assistance

FIG. 14. FIG. 14 illustrates how cateNet service in a senior family member requesting assistance contacts it participants

FIG. 15. FIG. 15 illustrates how cateNet service in a senior family member requesting assistance, the participants participates and communicates with each other to resolve the situation.

FIG. 16. FIG. 16 illustrates how cateNet service in a senior family member requesting assistance, the initiator acknowledges the help.

FIG. 17. FIG. 17 illustrates how cateNet service will be used in a situation at a corporation.

FIG. 18. FIG. 18 illustrates how cateNet service in a situation at a corporation contacts it participants

FIG. 19. FIG. 19 illustrates how cateNet service in a situation at a corporation, the participants participates and communicates with each other to resolve the situation.

FIGS. 20 and 21. FIGS. 20 and 21 illustrates how cateNet service in a situation at a corporation, an additional team is added to the communication and they take action.

FIGS. 22 and 23. FIGS. 22 and 23 illustrates how cateNet service in a situation at a corporation, an additional team is added to the communication and they take additional action to improve the situation.

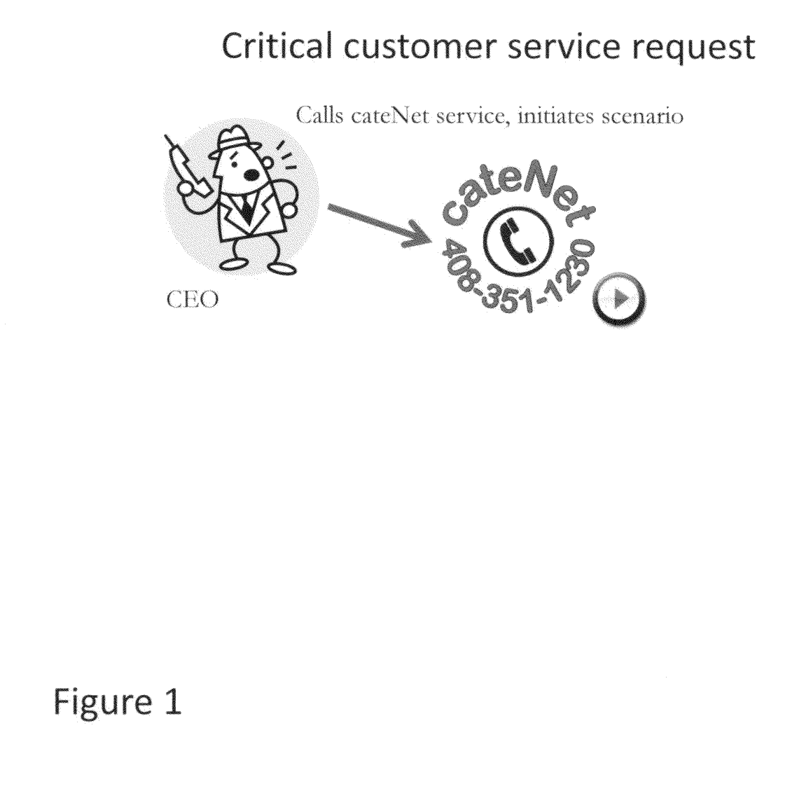

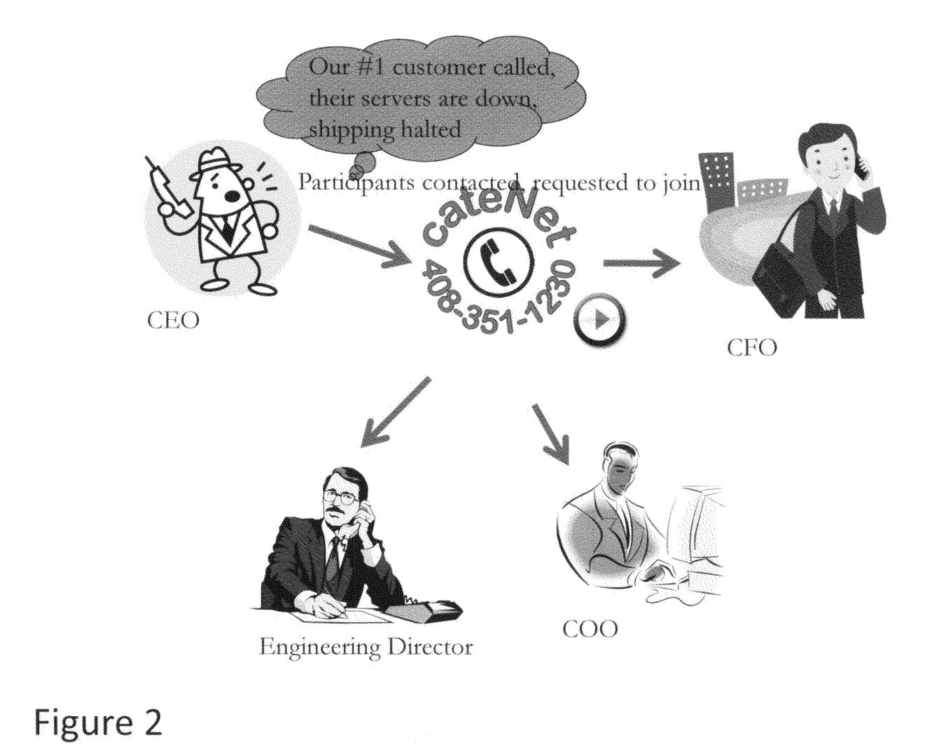

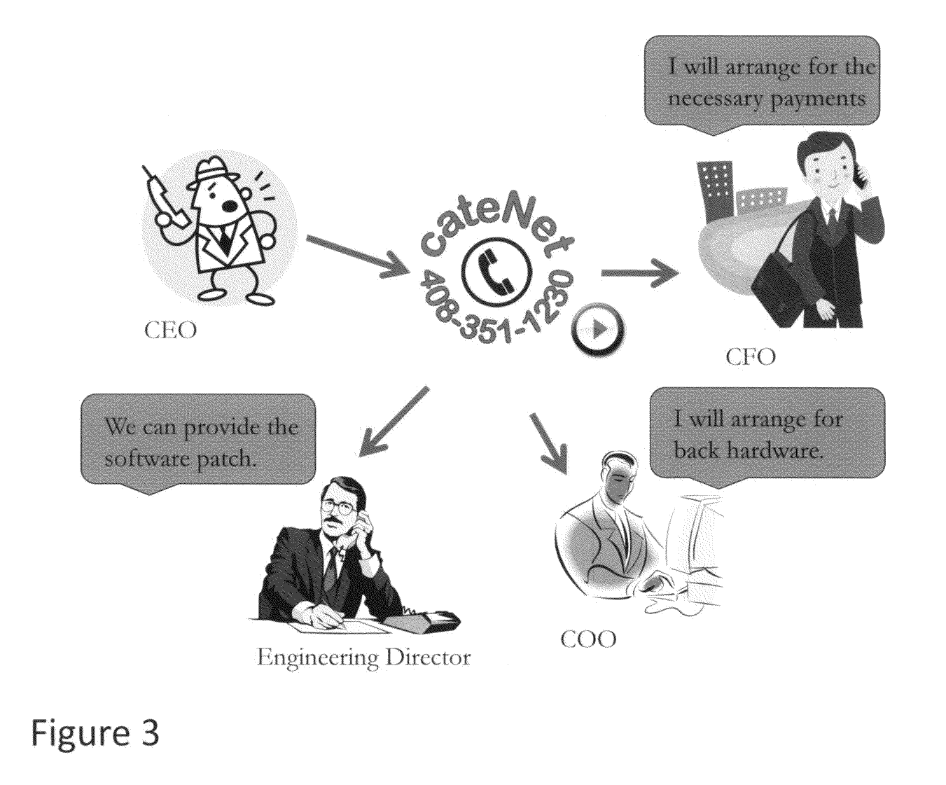

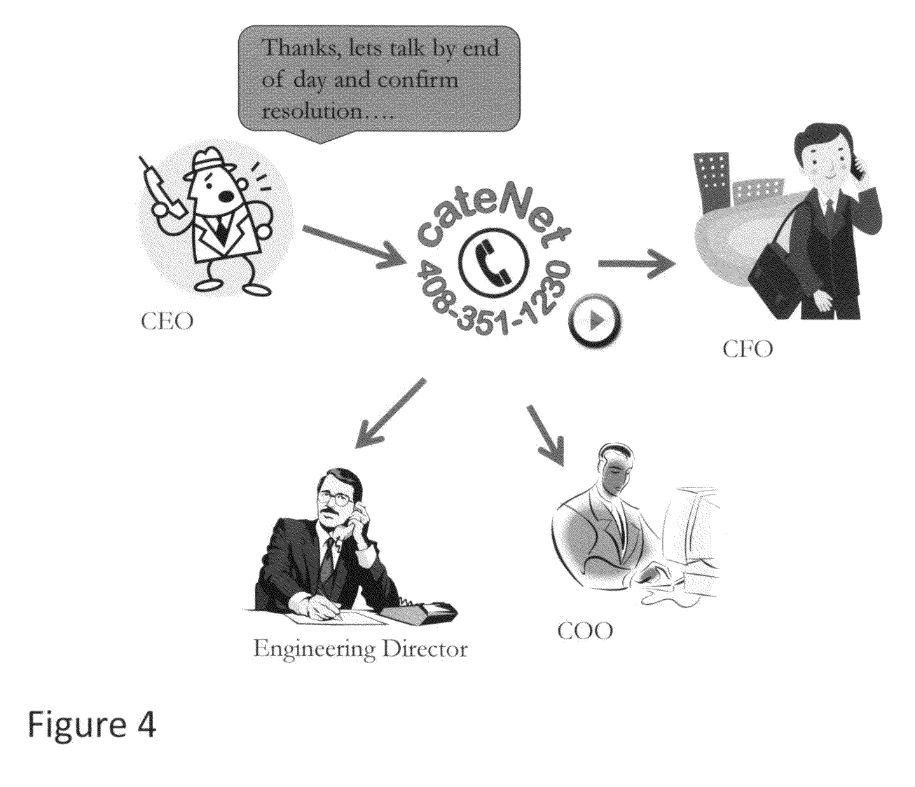

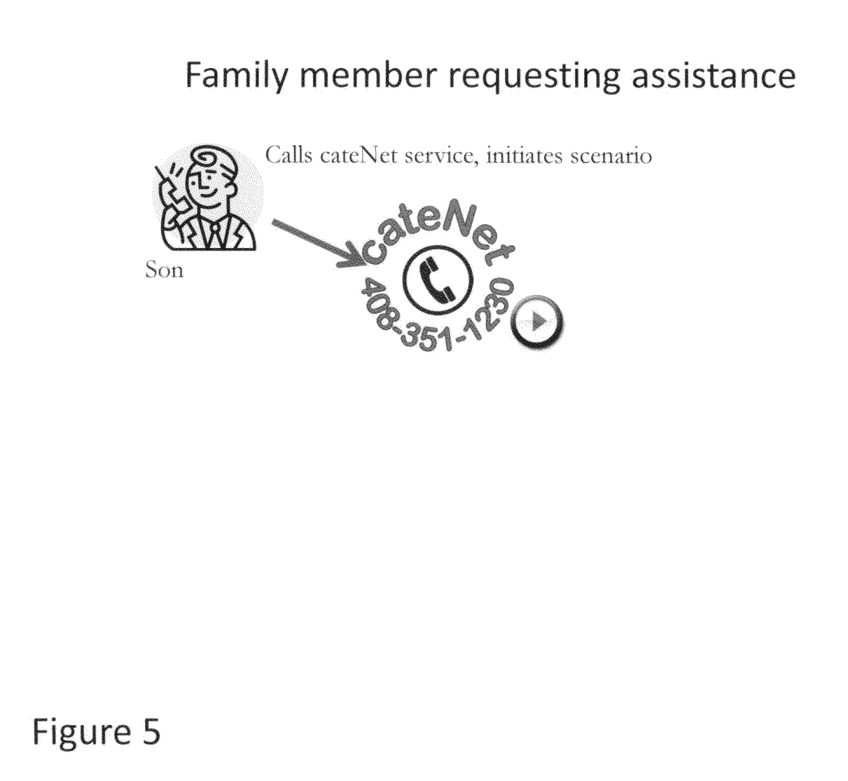

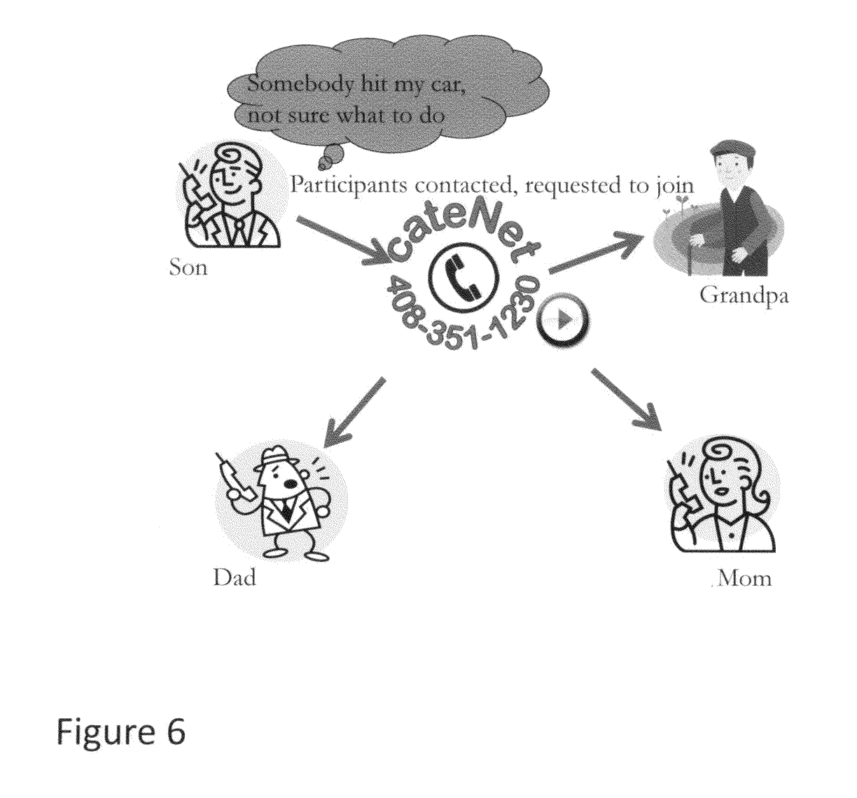

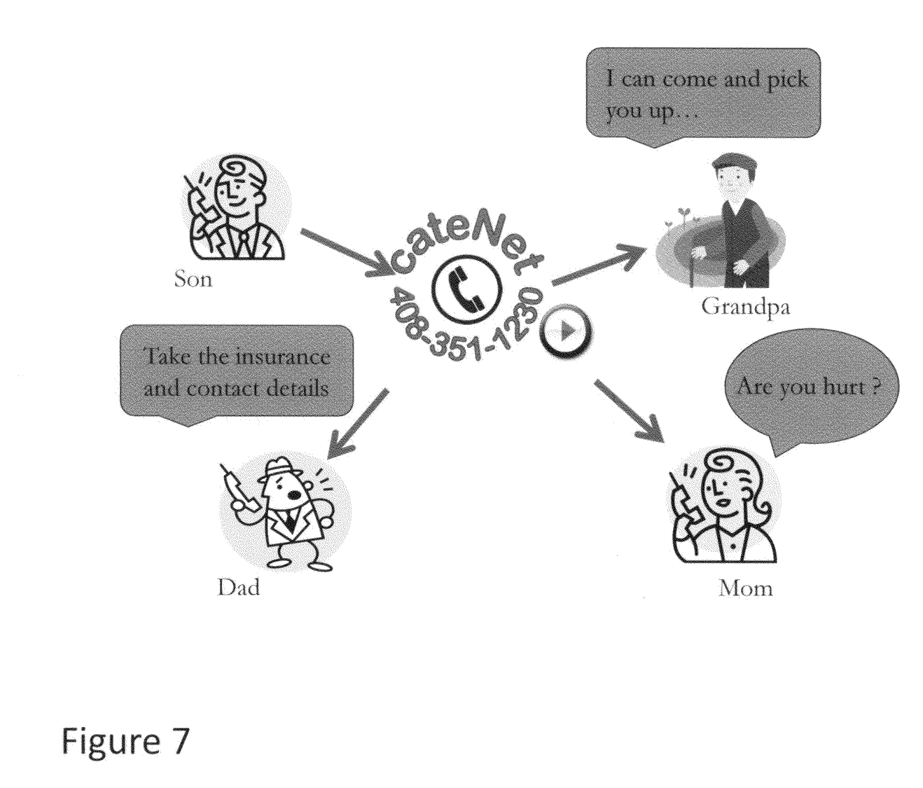

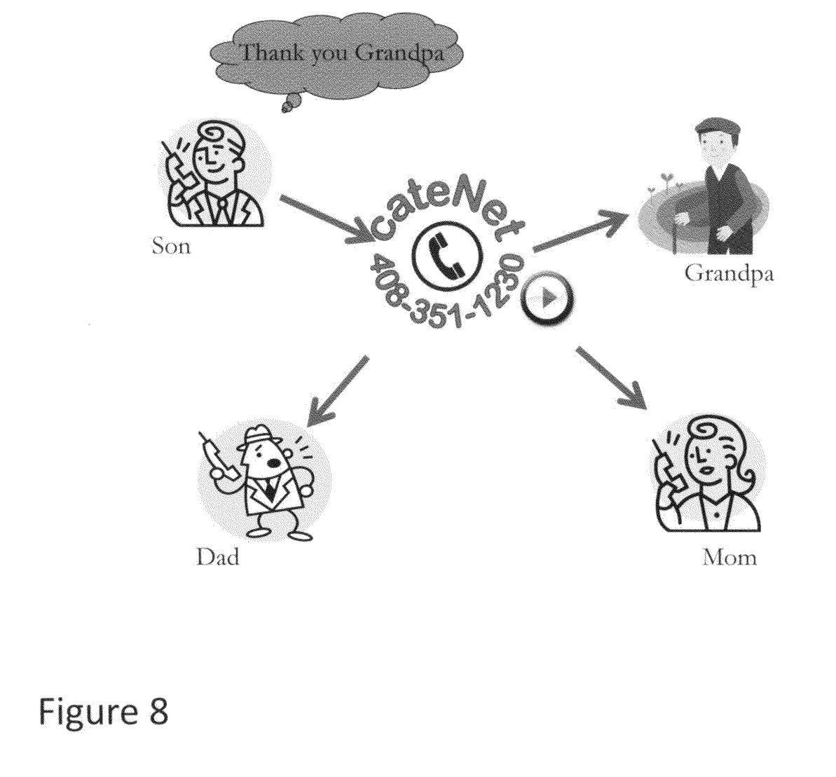

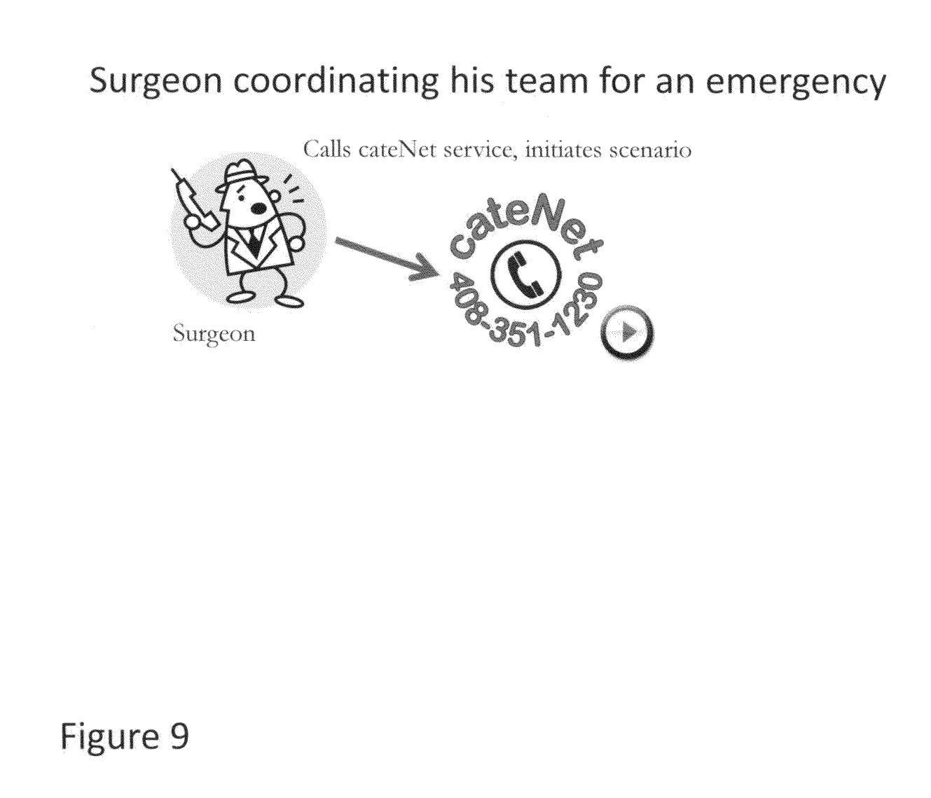

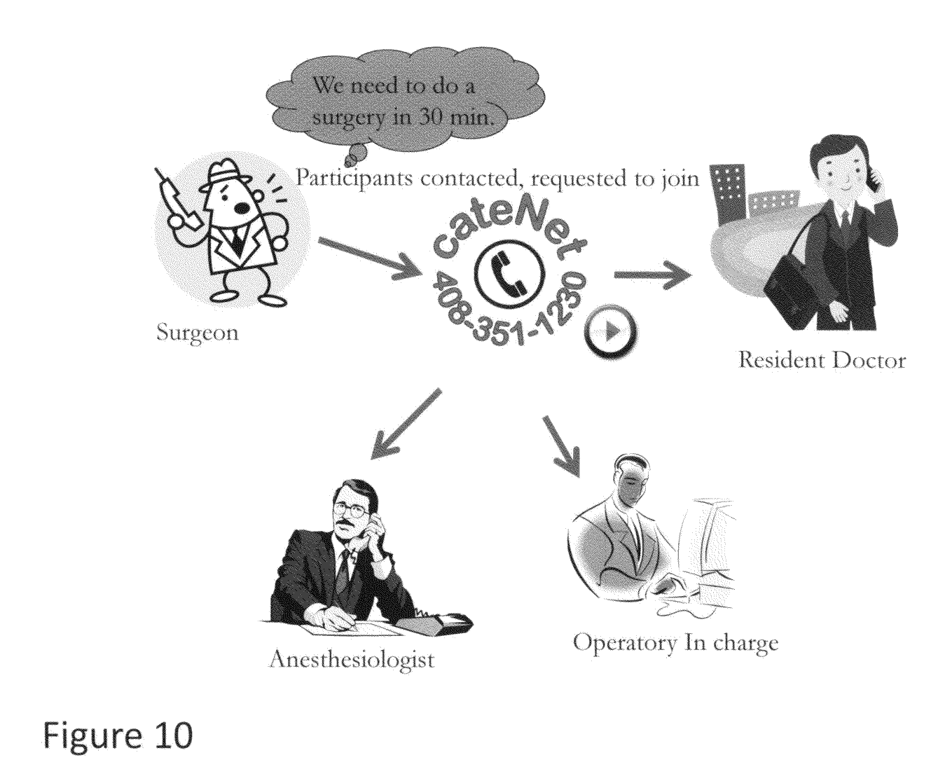

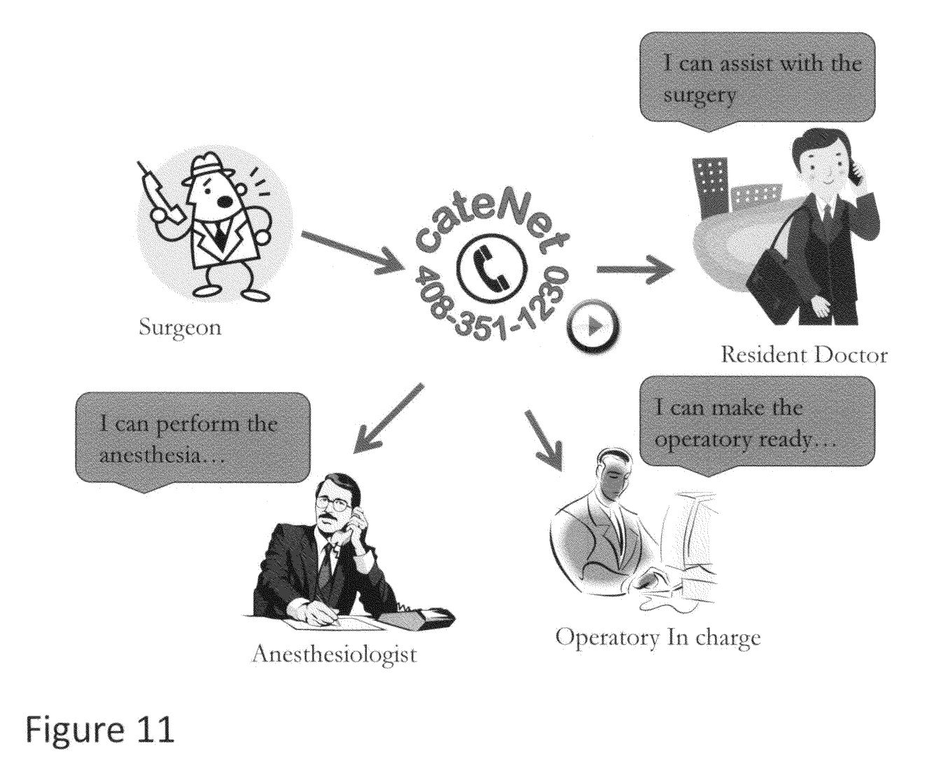

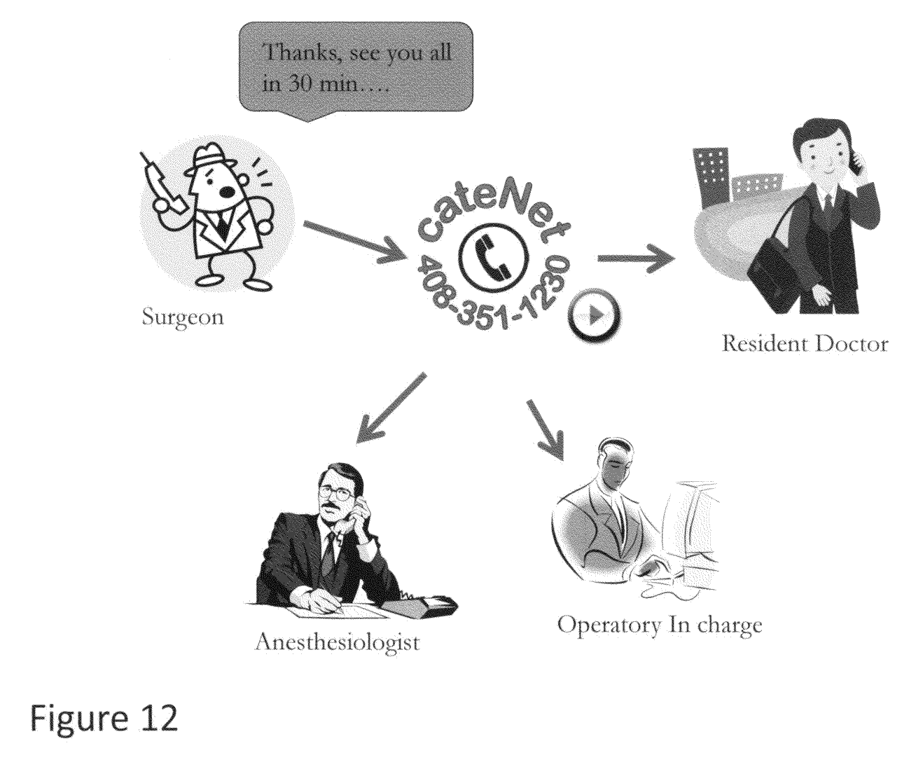

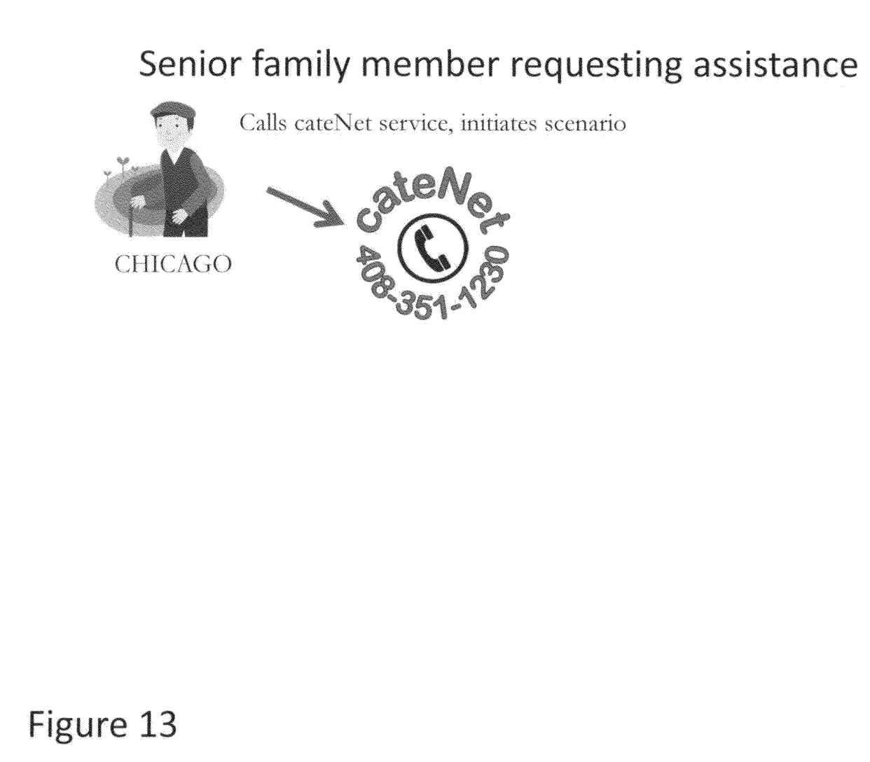

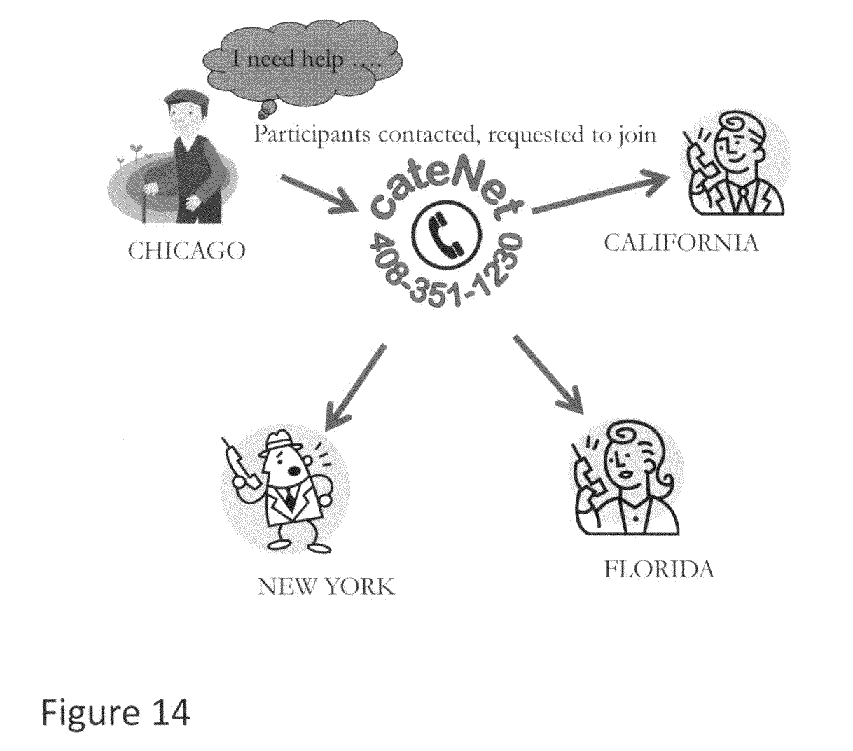

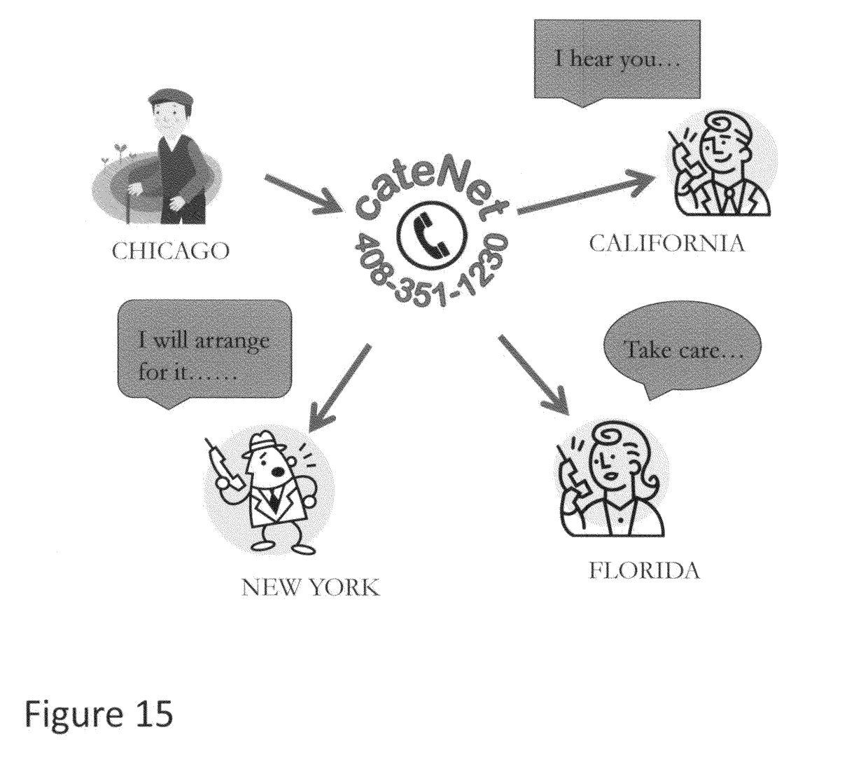

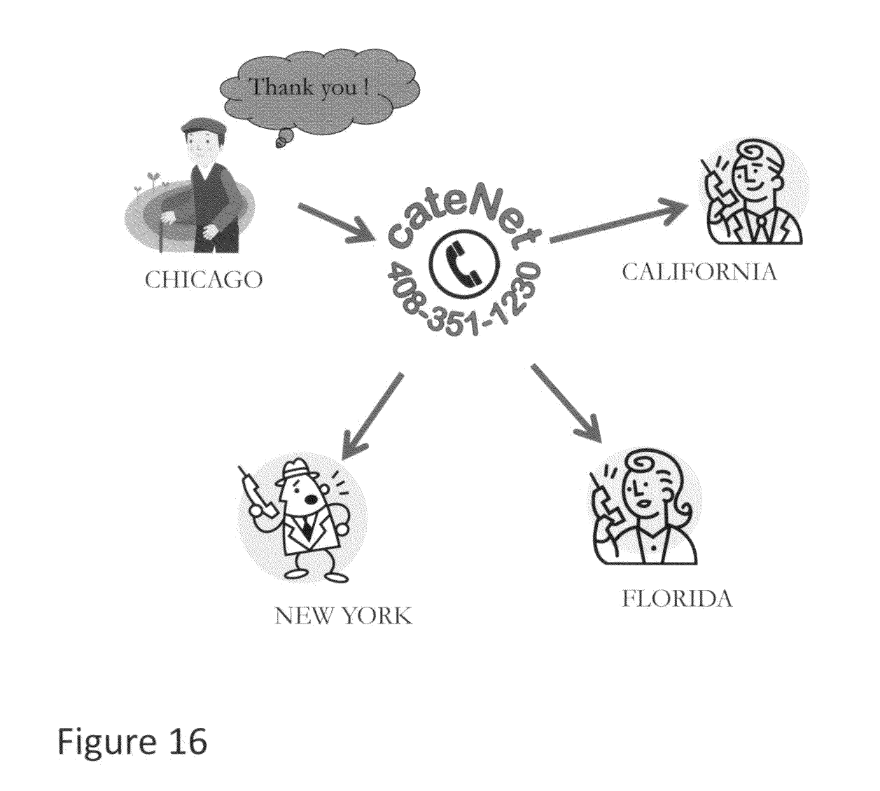

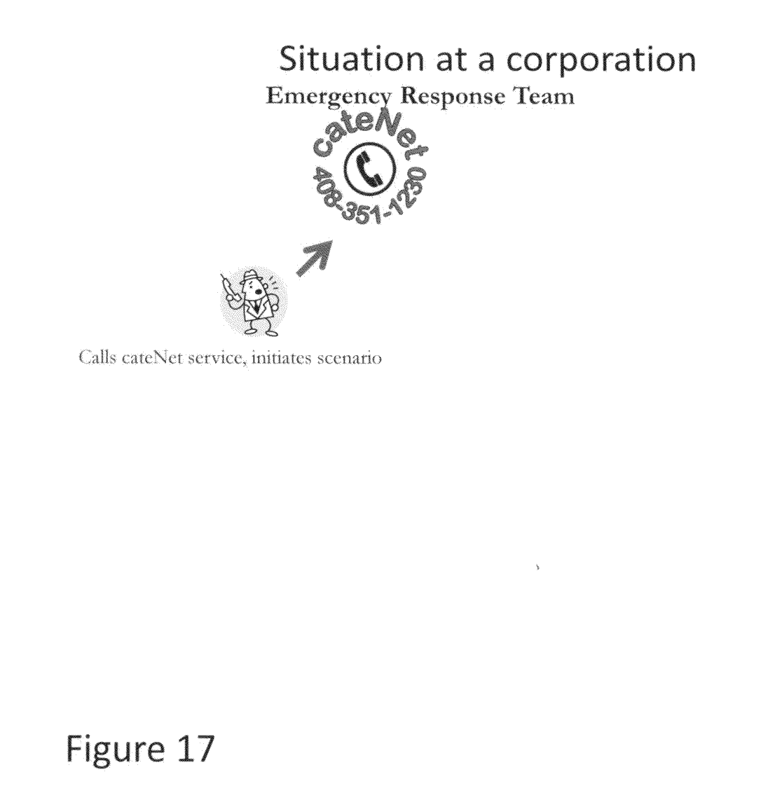

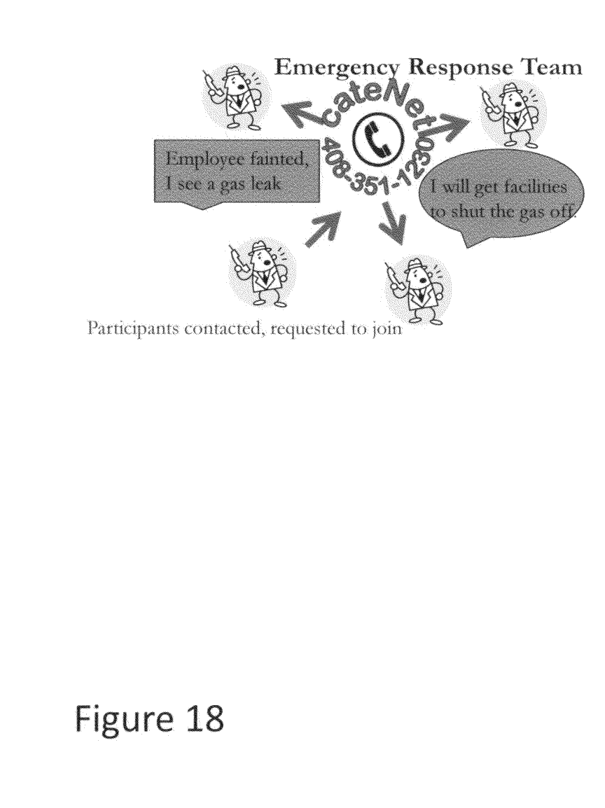

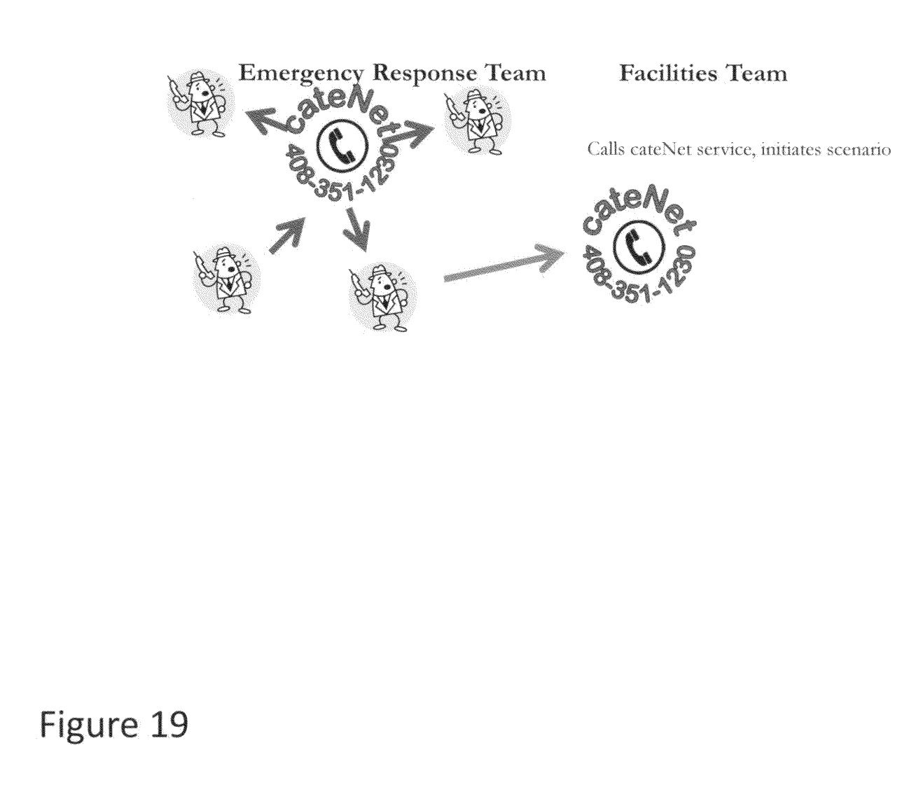

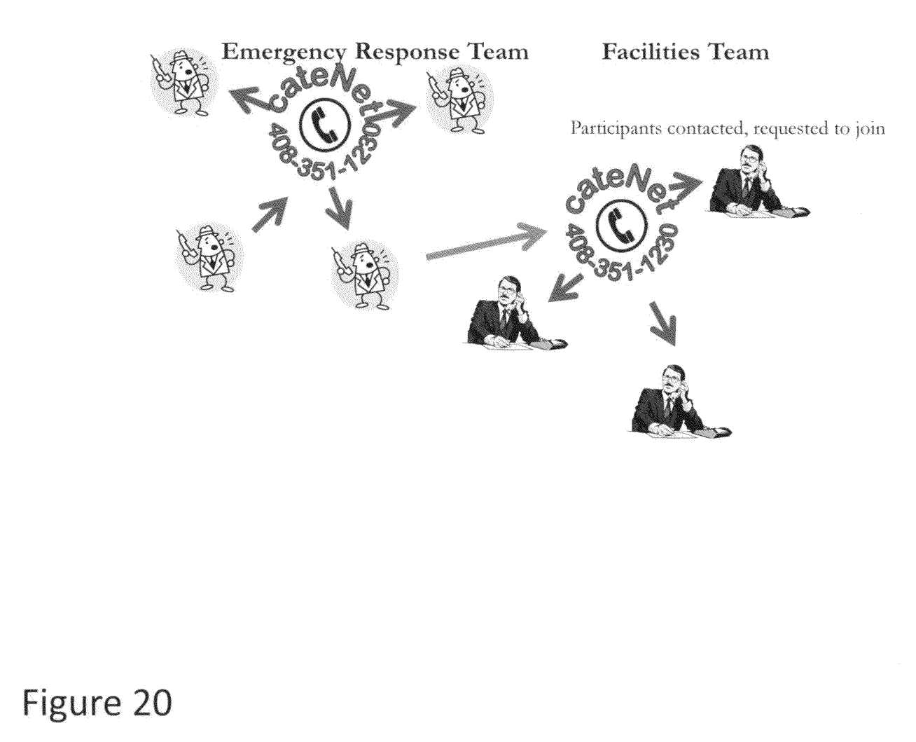

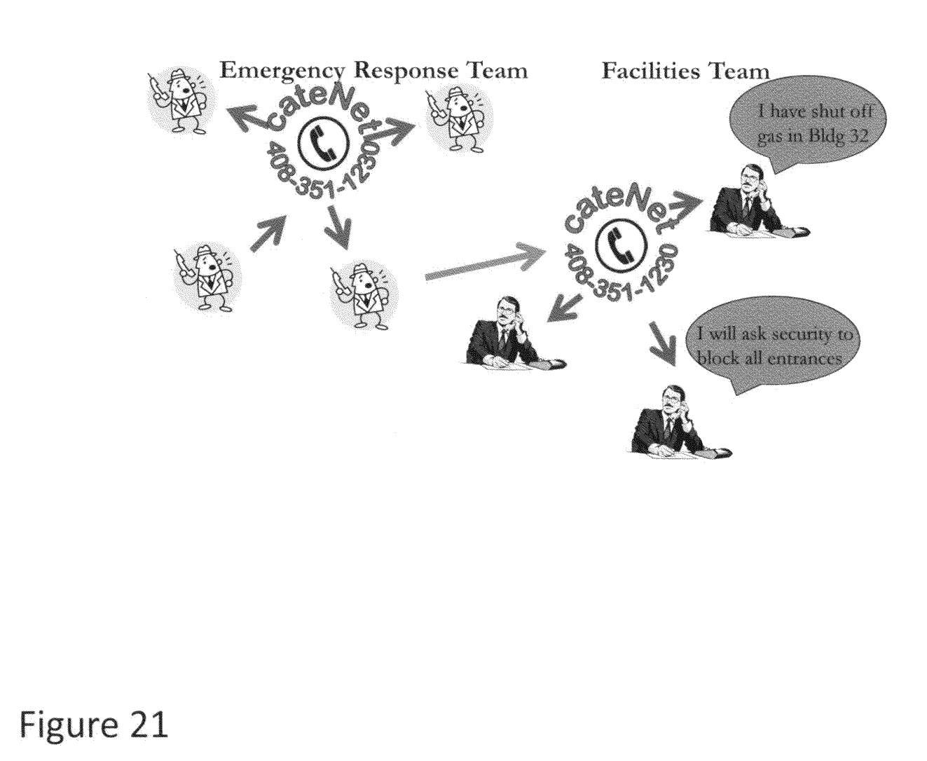

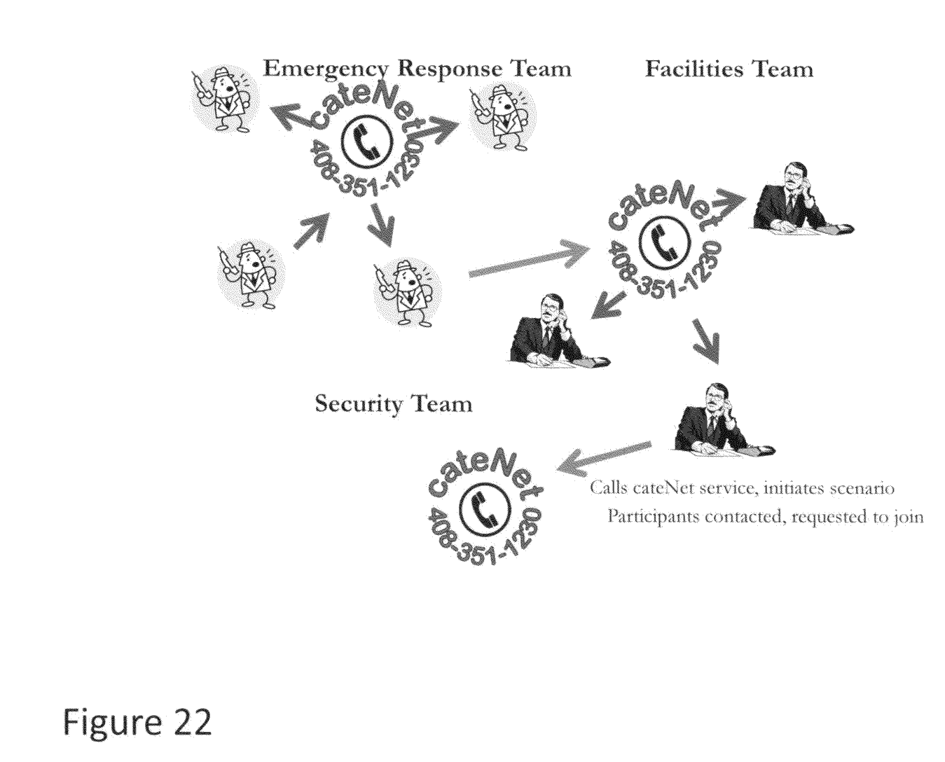

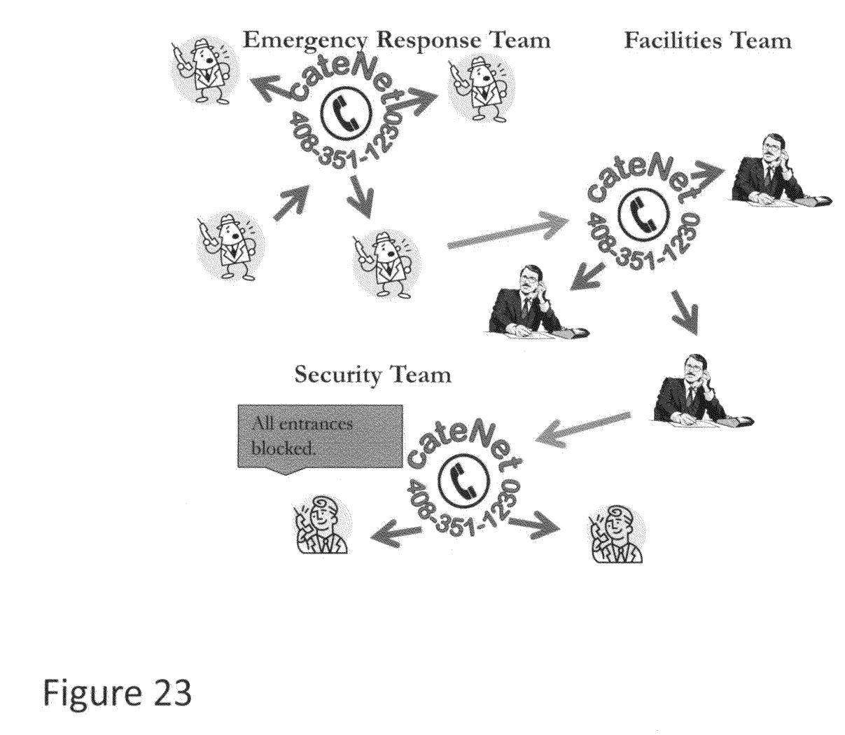

### DETAILED DESCRIPTION AND BEST MODE OF IMPLEMENTATION

Sign up for an account.

Identify the different situation in which you want to use this service (like the ones discussed in the service background).

Identify the necessary members as initiators or/and participants.

You can have more than 1 member be an initiator of the service. Call the service number (408-351-1230).

Select to be an initiator or a participant of the scenarios.

cateNet will list/read out all the scenarios. Select the right scenario.

cateNet will start the instant multiparty communication call and request all the participants to join.

You can record the conversations as needed.

Add additional parties by entering the number to join in.

If you are a participant and have missed the call, you can dial service number, it will list all the active instant multiparty communications in progress to join in.

You can also use the Smart Phone Apps to sign in and click on one of the scenarios setup to activate the instant multiparty communication.

I claim:

1. As a service offering the subscriber will be able to dial a specific service number and will get to talk to all the parties configured in the service. Set of parties can be configured as scenarios. If multiple scenarios are setup the subscriber will have to select the scenario to activate.

2. As part of the service offering in claim 1, the subscriber will be able to record the conversation by default or activate the recording function by press of a button.

3. As part of the service offering in claim 1, the subscriber will be able to connect to 911 services by default as soon as the number is dialed or get 911 services by press of a button.

4. As part of the service offering in claim 1, if one of the parties participating in this service misses the call, he will be able to dial back in to the call and join the discussion from that point onwards.

5. As part of the service offering in claim 1, the service can be configured so that either the owner of the service can activate the service or all the participants can. If any other member tries to activate they will not be successful.

6. As part of the service offering in claim 1, only the members configured in the service can use the service.

7. As part of the service offering in claim 1, the subscribers will be able to activate the service from smart phone and tablets.
